(19) United States
(12) Patent Application Publication
(10) Pub. No.: US 2007/0061304 A1
(43) Pub. Date: Mar. 15, 2007

(54) Middleware and a method for implementing business logic using it

(76) Inventors: Kwang Nam Gung, Seoul (KR); YunSeok Lee, Yonginsi (KR); NamHoon Byun, Yonginsi (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/389,870

(22) Filed: Mar. 27, 2006

(30) Foreign Application Priority Data
Sep. 13, 2005 (KR) 2005-85325

(51) Int. Cl. G06F 17/30

(52) U.S. Cl. 707/3

(57) ABSTRACT

The present invention relates to a middleware for data communication between legacy systems and clients via wired or wireless communication network. The middleware includes a business logic database for storing business logics, an object creating module for determining a legacy system with which a business logic operates and creating a business object for the business logic so that the business object can be handled by the legacy system, a business logic searching module for receiving a request for a business logic from a client and searching for the business logic in the business logic database, in case the business logic requested by the client exists in the business logic database, the business logic searching module returning the business object for the business logic created by the object creating module in response to the request, and an instance creating module for creating and returning an instance of the business object.

### CROSS-REFERENCE TO RELATED APPLICATIONS

The present application claims priority from a Korean patent application No. 2005-85325 filed on Sep. 13, 2005, the contents of which are incorporated herein by reference.

### BACKGROUND

1. Field

The present invention relates to a middleware for performing data communication between legacy systems of an enterprise system and mobile equipments and a method for implementing business logics using the middleware. More particularly, the present invention relates to a middleware for providing a user interface which enables a system administrator to manage business logics more easily.

2. Description of the Related Art

Recently, many enterprises try to integrate distributed computing systems for managing business functions. Further, it is an important object of an enterprise to construct an integrated system which makes business centralized and remote control of business of the outside possible by integrating mobile equipments such as a cellular phone, a PDA, a notebook, etc. with legacy systems and/or databases which have managed business functions inside of the enterprise.

Most enterprises have constructed and used their own computing systems and databases for managing business functions inside them. However, if an existing operating system or the construction of an existing database should be remarkably modified in order to construct this kind of integrated system, time and human power wasted and, in some cases, a business logic which has been used to manage a business function cannot be used as it is. Therefore, it is most desirable to integrate existing business management systems (or applications) and databases (hereinafter, referred to “legacy system”) with mobile equipments while using the legacy system as it is if at all possible.

In the meantime, conventionally, a business application for managing a specific business function is composed of a source code programmed in a language such as C, C++, JAVA, etc. and a business logic, for example, programmed in SQL statements buried in the source code. The business logic can be executed by compiling the whole program of the application. Further, in case the business logic buried in the application is changed, the whole program should be modified to amend the business logic. Furthermore, whenever the business logic is changed, the whole program should be recompiled before being executed.

Therefore, once the application is adopted by an integrated system, the whole application program should be modified to amend the business logic. If a system administrator of the integrated system does not understand the system thoroughly, there is a problem that it is very difficult for the system administrator to modify the business logic buried in the code of the application, and thus, system management time and cost are wasted.

### SUMMARY

Therefore, it is an object of the present invention to provide a middleware for integrating legacy systems with mobile clients without considerable change of the legacy systems. Especially, it is an object of the present invention to provide a user interface for making a system administrator easily manage business logics of the integrated system.

Further, it is an object of the present invention to provide a middleware which can be easily applied to the integrated system regardless of the kind of the operating system of the existing legacy system and database.

The above and other objects can be achieved by combinations described in the independent claims. The dependent claims define further advantageous and exemplary combinations of the present invention.

According to the first aspect of the present invention, a middleware for data communication between legacy systems and clients via wired or wireless communication network is provided, wherein the middleware includes a business logic database for storing business logics, an object creating module for determining a legacy system with which a business logic operates and creating a business object for the business logic so that the business object can be handled by the legacy system, a business logic searching module for receiving a request for a business logic from a client and searching for the business logic in the business logic database, in case the business logic requested by the client exists in the business logic database, the business logic searching module returning the business object for the business logic created by the object creating module in response to the request, and an instance creating module for creating and returning an instance of the business object.

According to the second aspect of the present invention, a method for implementing a business logic using a middleware for data communication between clients and legacy systems via wired or wireless communication network is provided, wherein the method includes steps of preparing a business logic database which stores business logics, determining a legacy system with which a business logic operates, creating a business object for the business logic so that the business object can be handled by the legacy system, receiving a request for a business logic from a client, searching for the business logic in the business logic database, in case the business logic requested by the client exists in the business logic database, returning the business object for the business logic in response to the request, and creating and returning an instance of the business object.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 is a schematic block diagram showing an integrated system of mobile clients and legacy systems using a middleware according to an embodiment of the present invention.

FIG. 2 is a block diagram showing an embodiment of the configuration of the middleware according to the present invention.

Each of FIGS. 3a and 3b show an example of a web page provided to a computer of the system administrator according to an embodiment of the present invention.

FIG. 4 is a schematic block diagram showing an example of a process flow of implementing a business logic according to an embodiment of the present invention.

FIG. 5 is a flowchart showing an example of a method for implementing a business logic using the middleware according to an embodiment of the present invention.

### DETAILED DESCRIPTION OF EMBODIMENTS

The invention will now be described based on the preferred embodiments, which do not intend to limit the scope of the present invention, but exemplify the invention. All of the features and the combinations thereof described in the embodiment are not necessarily essential to the invention.

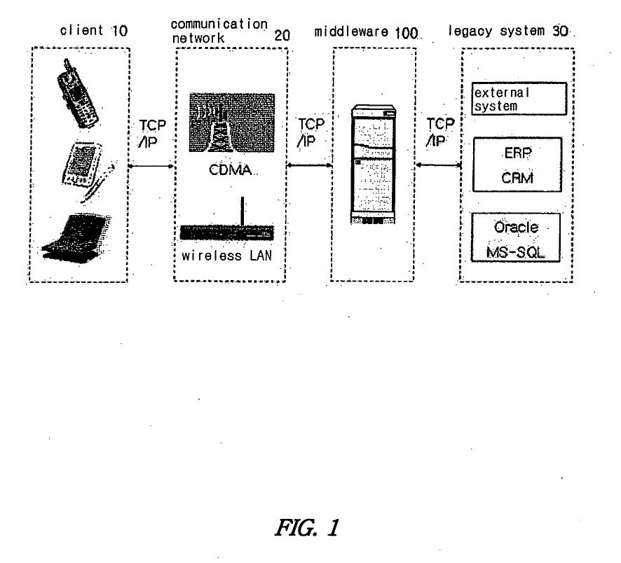

FIG. 1 is a schematic block diagram showing an integrated system of mobile clients and legacy systems using a middleware according to an embodiment of the present invention. As shown in FIG. 1, a mobile communication equipment (hereinafter, “client”) 10 is connected with a middleware 100 via a communication network 20 (wired communication network or wireless communication network such as CDMA, wireless LAN, etc.). The middleware 100 is connected with a server including legacy systems 30. The middleware 100 includes a gateway for transmitting data between the client 10, the middleware 100, and the legacy system 30. Since the configuration of the gateway is not the core of the present invention and hardware or software techniques for embodying the gateway are well-known in the art pertaining to the present invention, detailed description on the gateway is omitted in the present application.

The legacy system 30 may be a commercial enterprise application such as an ERP (Enterprise Resource Planning) system, a CRM (Customer Relationship Management) system, SAP R/3, etc. or a database management system such as Oracle, MS-SQL, etc. Further, the legacy system 30 may be not only this kind of enterprise application for managing only business functions of an enterprise but also an external system. In this case, the middleware 100 connects with the external system using the socket communication. In addition, the legacy system 30 includes various processors for data processing.

The middleware 100 of the present invention can be used for integration of legacy systems and mobile clients even in case there are various kinds of legacy systems. Further, the middleware 100 can provide a user interface which enables a system administrator to easily manage business logics of the integrated system. The configuration and advantages of the middleware 100 will be described in the following in detail.

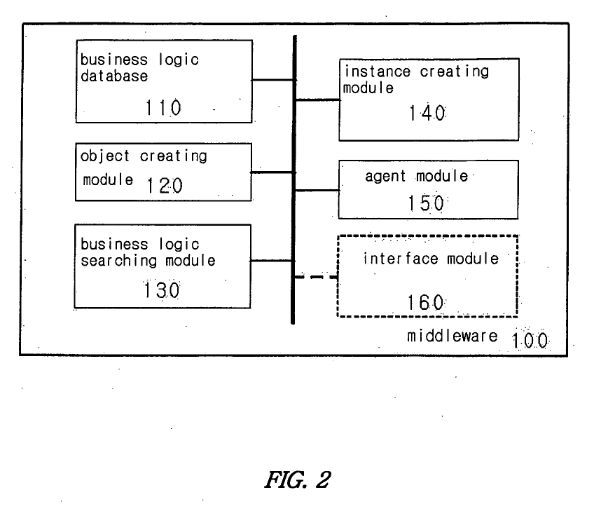

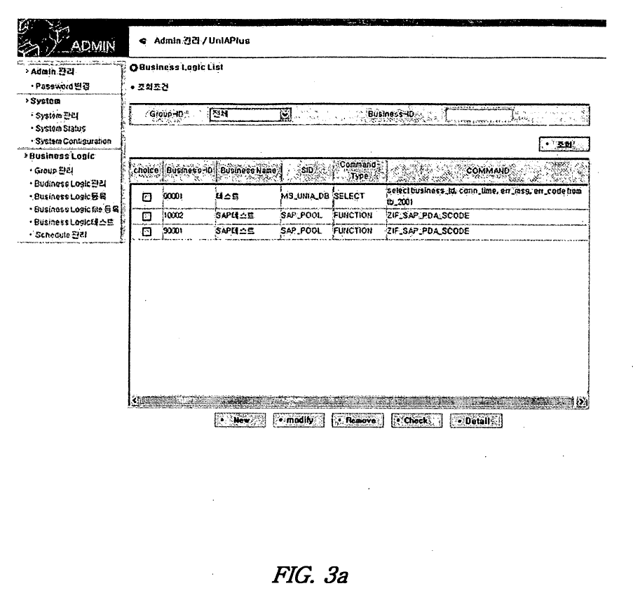

FIG. 2 is a block diagram showing an embodiment of the configuration of the middleware 100 according to an embodiment of the present invention.

The middleware 100 includes a business logic database 110, an object creating module 120, a business logic searching module 130, an instance creating module 140, and an agent module 150.

The business logic database 110 stores business logics each of which is the set of procedures or methods used to manage a specific business function. The type of a business logic is different according to the kind of a legacy system with which the business logic operates. For example, a business logic which operates with a DBMS system includes SQL statements, functions, procedures, etc., and a business logic which operates with SAP/R3 includes SAP functions included in the sap&jco library. In case the legacy system is an external system, a business logic includes data of a protocol type for socket communication.

As above, since the middleware 100 of the present invention includes a database for storing business logics separated from the legacy application program code, it is easier to manage the business logics, for example, remove a business logic from the database, modify a business logic stored in the database, or add a new business logic to the database, in comparison with the conventional integrated system in which a business logic is buried in a legacy application program code.

It is desirable that the business logic database 110 stores a business logic identifier that is an identifier of each of the business logics and a legacy system identifier that is an identifier of a legacy system with which the business logic operates, as well as the business logics. This feature will be described in the following in detail.

The object creating module 120 creates business objects for the business logics stored in the business logic database 110. Taking the object-oriented approach, a business function defined by the business logic is decomposed into a set of components or elements. The set of components or elements is called a business object. In other words, the set of business-specific rules that help identify the structure and behavior of the business object, along with the pre- and post- conditions that must be met when an object exposes its behavior to other objects in the system, is known as a business logic. Further, the business object has some type of infrastructure to support the conversation with a client or a legacy system.

In case the business logic database 110 stores the legacy system identifier together with the business logic as described above, the object creating module 120 can be aware of which legacy system operates with the business logic with through the legacy system identifier and create a business object having infrastructure for supporting the conversation with the legacy system.

The client 10 sends a request for a business logic for performing data processing which it requires. The business logic searching module 130 searches for the business logic which the client 10 asks for out of the business logics stored in the business logic database 110. In the present embodiment, as described above, the business logic database 110 may store business logic identifiers together with the business logics. In this case, the client 10 sends an identifier of the business logic which it asks for as well as data which should be processed by the business logic (hereinafter, referred to “data to be processed”) to the middleware 100. In the present embodiment, the business logic searching module 130 can determine whether or not there is the business logic in the business logic database 110 by comparing the identifier received from the client 10 with the business logic identifiers stored in the business logic database 110.

The instance creating module 140 creates an instance of the business object created by the object creating module 120.

Further, the middleware 100 may further include an agent module 150. The agent module 150 functions as a channel for data communication between the modules described above and makes the structure of the middleware 100 easily modulated. More specifically, the middleware 100 including the business logic database 110, the object creating module 120, the business logic searching module 130, and the instance creating module 140, the client 10, and the legacy system 30 send/receive data to/from each other via the agent module 150. For example, the agent module 150 receives data to be processed and a request for searching for a business logic from the client 10 via the gateway and transfers the request to the business logic searching module 120. Further, the agent module 150 transfers a business object for a business logic created by the object creating module 130 to the instance creating module 140 and an instance of the business object created and returned by the instance creating module 140 to the legacy system 30 with which the business logic operates. Further, the agent module 150 transfers a result of data processing received from the legacy system 30 to the client 10.

According to the above configuration, in case there is a request for data processing from the client 10, the middleware 100 searches for a business logic required for the data processing by the client 10 and creates a business object for the business logic so that the business object can be handled by the legacy system 30. Thus, it is possible to make the data processing performed without trouble while no additional work is done even in case various kinds of equipments of the client and the legacy systems are used. Specifically, since an instance is created at once when needed, data processing between the client and the legacy system can be performed on real-time.

Further, the application source code needs not to be changed in case addition, removal, or modification of a business logic is required because business logics are stored in the business logic database 110 separately. This enables a system administrator to concentrate on solving business problems of the enterprise instead of expending his or her efforts on system-level issues and remarkably improves flexibility of the system.

In order to provide an interface which makes system administration easier, the middleware 100 may further include an interface module 160. The interface module 160 provides an interface between the integrated system as shown in FIG. 1 and the system administrator, which enables the system administrator to control the business logics stored in the business logic database 110. For this, in the present embodiment, the interface module 160 generates a web page or a text page via which the system administrator can control a business logic directly and provides it to the system administrator.

For example, FIG. 3 shows an example of this kind of web page for system administrators. FIG. 3a shows an example of a web page for displaying a list of business logics stored in the business logic database 110. There are buttons of “New”, “modify”, “Remove”, “Check”, and “Detail” in the lower part of the page. The button of “New” is provided to create a new business logic and store the business logic in the business logic database 110. The buttons of “modify”, “Remove”, and “Check” are provided to modify, remove, and check a business logic stored in the business logic database 110, respectively. The button of “Detail” is provided to set details of a business logic stored in the business logic database 110.

FIG. 3b shows how to add a business logic through the web page shown in FIG. 3a. If the system administrator pushes the button of “New” in the lower part of the web page shown in FIG. 3a, a new window shown in FIG. 3b is generated and activated. The window includes various fields such as Group to which a business logic belongs, Command-Type, Business ID which is an identifier of the business logic, Name of the business logic, whether or not transaction is checked, SID which is an identifier of a legacy system, and Command. When the system administrator inputs a value of every field and then pushes a button of “Save”, the business logic which is defined by the field values input by the system administrator is registered in the business logic database 110. Since a method for modifying or removing a business logic is similar with the method for adding a business logic described above, detailed description on how to modify or remove a business logic is omitted.

As described above, the middleware according to the present invention includes a separate database for storing business logics and thus can provide an interface which makes the system administrator manage business logics more easily.

Further, since the system administrator can perform removal, modification, addition of a business logic, and the like, by using the interface provided to the system administrator's computer without modifying the whole application program code unlikely the conventional integrated system. Therefore, even a system administrator who is poorly-informed about system-level issues can manage business logics very easily.

It is desirable that each of the modules 110, 120, 130, 140, 150, and 160 is realized using an object-oriented language such as JAVA. Note that a person skilled in the art can easily embody the modules referring to the above description. A specific method for realizing each module is not described in detail in the present application because it is no more simple change in design for a person skilled in the art and has no effect on the scope of the present invention.

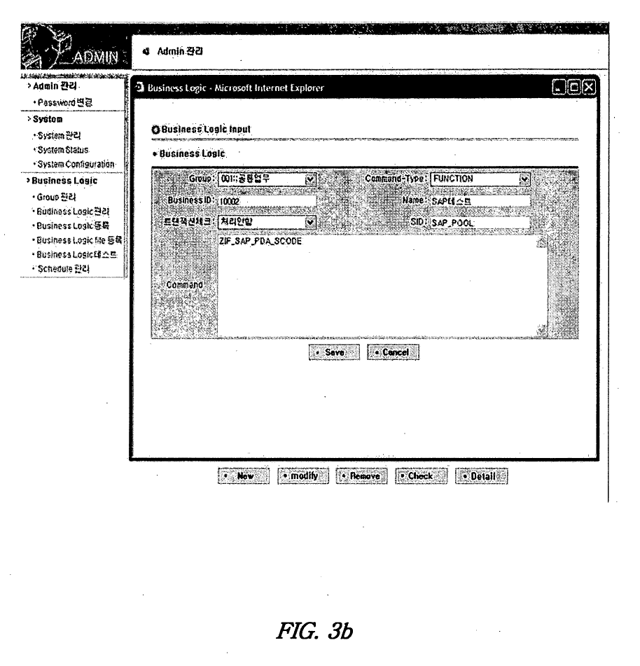

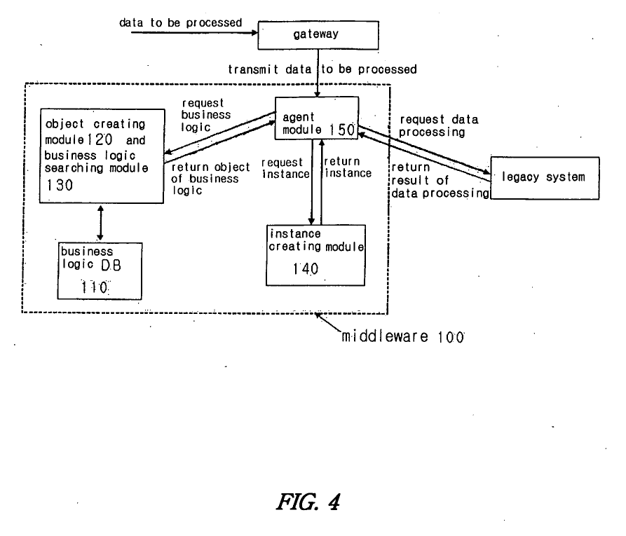

FIG. 4 is a schematic block diagram showing an example of a process flow of implementing a business logic according to an embodiment of the present invention.

When a connection between a client 10 and the middleware 100 is made and a session is assigned to the client 10, the client 10 sends data to be processed to the gateway. Then, the gateway assigns a thread which is in charge of data communication with the client 10 to the session and transfers the data to be processed to the agent module 150 of the middleware 100.

Then, business logics stored in the business logic database 110 are loaded and the object creating module 120 creates business objects for the business logics so that the business objects can properly carry out their functionality.

In the meantime, the agent module 150 transfers a request for a business logic which is required for processing the data received from the client 10 to the business logic searching module 130 and the business logic searching module 130 searches for the business logic. If the business logic is found out from the business logic database 110, the business logic searching module 130 returns the business object for the business logic created by the object creating module 120 to the agent module 150.

If the business logic is not found out from the business logic database 110, it is desirable that an error message is generated and transferred to the client 10 and/or the system administrator.

The agent module 150 receives the business object and transfers it to the instance creating module 140. Then, the instance creating module 140 creates an instance of the business object and returns the instance to the agent module 150.

It is desirable to make clear whether the legacy system 30 is available for data processing before transferring the instance to the legacy system 30. In case it is determined that the legacy system 30 is not available, an error message is generated and sent to the client 10 and/or the system administrator. In case it is determined that the legacy system 30 is available, the agent module 150 transfers the instance to the legacy system 30. Then, when a result of data processing is returned to the agent module 150, it sends the result to the client via the gateway.

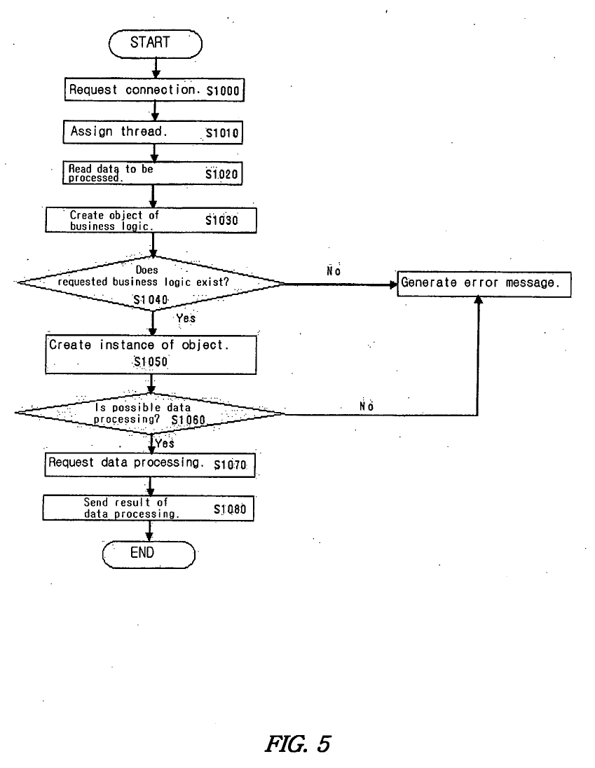

FIG. 5 is a flowchart showing an example of a method for implementing a business logic using the middleware 100 according to an embodiment of the present invention.

When connection between a client 10 and the server is made (S1000), a session is assigned to the client 10 and a thread which will take in charge of communication between the client 10 and the server is requested to the thread pool. At this moment, in case there is a spare thread which is available in the thread pool, the spare thread is assigned to the client session. In case there is no spare thread in the thread pool, the number of simultaneous connections is checked. If the number of connections does not exceed the maximum allowable simultaneous connections, a thread is created and assigned to the client session. Otherwise, the client 10 waits for a thread to be assigned.

When the thread is assigned to the client session (S1010), data to be processed and an identifier for identifying a business logic which is required to process the data are sent to the agent module 150 of the middleware 100 from the client 10 (S1020).

At this moment, business logics stored in the business logic database 110 are loaded and the object creating module 120 creates business objects for the business logics. For each of the business logics stored in the business logic database 110, the object creating module 120 determines which legacy system operates with the business logic, for example, on the basis of the legacy system identifier which corresponds to the business logic and is stored in the business logic database 110. Thus, the object creating module 120 creates a business object for the business logic which has infrastructure to support the conversation with the legacy system (S1030).

Then, the business logic searching module 130 searches for the business logic requested by the client 10 out of the loaded business logics (S1040). In case there is not the business logic requested by the client 10 in the business logic database 110 (S1040: No), an error message is generated and sent to the client 10 and/or the system administrator. When receiving the error message, the system administrator may make and input a new business logic via a window page or a text page provided by the user interface as described above.

In case there is the business logic requested by the client 10 in the business logic database 110 (S1040: Yes), the business object for the business logic is returned to the agent module 150.

Then, the agent module 150 transfers the business object to the instance creating module 140. The instance creating module 140 creates an instance of the business object and returns the instance to the agent module 150 (S1050).

Then, it is determined whether the legacy system with which the business logic operate is available for data processing (S1060). In case the legacy system is not available (S1060: No), an error message is generated and sent to the client 10 and/or the system administrator. In the meantime, in case the legacy system is available (S1060: Yes), the agent module 150 transfers the instance created by the instance creating module 140 to the legacy system 30 (S1070). When the data processing is completed, a result of the data processing is returned to the agent module 150 (S1080).

According to the present invention, business logics are stored in a separate database, which makes management of the business logics, such as modification, addition, and deletion, simple and easy. Further, it is possible to easily realize a user interface via which the system administrator manages the business logics directly. By this, flexibility of the integrated system remarkably improves.

In addition, even a system administrator who is poorly-informed about system-level issues can manage business logics very easily. Thus, it is possible to notably reduce system management time and expenses.

Although the present invention has been described by way of exemplary embodiments, it should be understood that those skilled in the art might make many changes and substitutions without departing from the spirit and the scope of the present invention which is defined only by the appended claims.

What is claimed is:

1. A middleware for data communication between legacy systems and clients via wired or wireless communication network, comprising:
a business logic database for storing business logics;
an object creating module for determining a legacy system with which a business logic operates and creating a business object for said business logic so that said business object can be handled by said legacy system;
a business logic searching module for receiving a request for a business logic from a client and searching for said business logic in said business logic database, in case said business logic requested by said client exists in said business logic database, said business logic searching module returning said business object for said business logic created by said object creating module in response to said request; and
an instance creating module for creating and returning an instance of said business object.

2. The middleware as claimed in claim 1, further comprising an agent module for transferring said request received from said client to said business logic searching module, said business object returned by said business logic searching module to said instance creating module, and said instance returned by said instance creating module to said legacy system.

3. The middleware as claimed in claim 1, wherein said business logic database further stores a business logic identifier, which is an identifier for identifying each of said business logics, correspondingly to said business logic, wherein said request received from said client includes an identifier for identifying said requested business logic, and wherein said business logic searching module searches for said requested business logic by comparing said identifier included in said request received from said client and said business logic identifiers stored in said business logic database.

4. The middleware as claimed in claim 1, further comprising an interface module which is connected with a computer for a system administrator and which provides to said system administrator with an interface for enabling said system administrator to modify or remove a business logic stored in said business logic database, or to add a new business logic to said business logic database.

5. The middleware as claimed in claim 4, wherein said interface module generates a web page or a text page via which said system administrator modifies or removes a business logic in said business logic database or adds a business logic to said business logic database and provides said web page or text page to said computer for said system administrator.

6. The middleware as claimed in claim 1, wherein said business logic database stores a legacy system identifier that is an identifier for identifying a legacy system with which each of said business logics stored therein operates, correspondingly to said business logic, and wherein said object creating module determines which legacy system operates with a business logic on the basis of said legacy system identifier stored in said business logic database correspondingly to said business logic.

7. A method for implementing a business logic using a middleware for data communication between legacy systems and clients via wired or wireless communication network, comprising:
(1) preparing a business logic database which stores business logics;
(2) determining a legacy system with which a business logic operates;
(3) creating a business object for said business logic so that said business object can be handled by said legacy system;
(4) receiving a request for a business logic from a client;
(5) searching for said business logic in said business logic database;
(6) in case said business logic requested by said client exists in said business logic database, returning said business object for said business logic created in said step (3) in response to said request; and
(7) creating and returning an instance of said business object.

8. The method as claimed in claim 7, further comprising a step (7-1) of transferring said instance to said legacy system with which said business logic operates.

9. The method as claimed in claim 7, further comprising a step (1-1) of storing a business logic identifier which is an identifier for identifying each of said business logics stored in said business logic database correspondingly to said business logic, wherein said request received from said client in said step (4) includes an identifier of said business logic requested by said client, and in step (5), said business logic requested by said client is searched for by comparing said identifier included in said request received from said client and said business logic identifiers stored in said business logic database.

10. The method as claimed in claim 7, further comprising a step (8) of providing a system administrator with an interface which enables said system administrator to modify or remove a business logic stored in said business logic database, or to add a new business logic to said business logic database.

11. The method as claimed in claim 10, wherein said interface includes a web page or a text page provided to a computer for said system administrator.

12. The method as claimed in claim 7, further comprising a step (1-2) of storing a legacy system identifier that is an identifier for identifying a legacy system with which each of said business logics stored in said business logic database operates, correspondingly to said business logic, wherein in said step (2), it is determined which legacy system operates with a business logic on the basis of said legacy system identifier stored in said business logic database correspondingly to said business logic.
